(19) United States
(12) Patent Application Publication
(10) Pub. No.: US 2013/0151992 A1
(43) Pub. Date: Jun. 13, 2013

(54) ENHANCED PERCEPTION OF MULTI-DIMENSIONAL DATA

(71) Applicants: Jean E. Greenawalt, Palm Harbor, FL (US); James W. Nelson, Englewood, FL (US)

(72) Inventors: Jean E. Greenawalt, Palm Harbor, FL (US); James W. Nelson, Englewood, FL (US)

(73) Assignee: Raytheon Company, Waltham, MA (US)

(21) Appl. No.: 13/315,981

(22) Filed: Dec. 9, 2011

(51) Int. Cl. G06F 3/048

(52) U.S. Cl. 715/757

(57) ABSTRACT

A system for analyzing multi-dimensional data maps the multi-dimensional data to visual attributes and aural attributes. It displays a subset of the multidimensional data set on a display unit. The system further displays an avatar on the display unit. The avatar can select a field of view of the displayed subset. The system receives input from a user, wherein the user input relates to an additional dimension subset of the multidimensional data set that is not currently displayed. Visual attributes and/or aural attributes relating to the additional dimension subset are generated as a function of the input from a user. The visual and/or aural attribute convey information relating to the additional dimension subset on the display unit.

### TECHNICAL FIELD

The current disclosure relates to a computer system that displays multi dimensional data, and in an embodiment, but not by way of limitation, a system for analysis of multi-dimensional data.

### BACKGROUND

A data analyst typically produces two dimensional (2D) and sometimes flat three dimensional (3D) plots of tabular data on standard 2D display devices. For proper analysis, the analyst may have to produce many different plots at different scaling, actors, filtering on the various values within the rows and columns of the tabular data. Additional dimensions are typically represented by using different symbols (square, triangle, etc.) and colors. Such a methodology is time-consuming and does not easily show a global view or the ‘big picture’. In addition, a user viewing data in fiat 3D on a standard display cannot perceive depth to differentiate small nearby objects from distant large objects, a time-consuming limitation requiring manual rotation and zoom.

### BRIEF DESCRIPTION OF THE DRAWINGS

FIG. 1 illustrates an example of a display of a flat three dimensional plot including data points, an avatar, an avatar field of view, a device to receive input pertaining to additional dimensions beyond 3D, and a text view.

FIG. 2 illustrates a collaboration space associated with the display of FIG. 1.

FIG. 3 is a flowchart of an example embodiment of a process to analyze multi-dimensional data.

FIG. 4 is a block diagram of an example embodiment of a computer processor system in connection with which embodiments of the current disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Currently, a data analyst is normally faced with a daunting pile of data and is tasked with picking out what aspects of the data to visualize. An embodiment of this disclosure is a paradigm shift from these current practices of data analysis, wherein the data is essentially rendered all at once within an expanded display of a 3D visualization environment. The task then for the analyst is to navigate through the data in 3D space and modulate the appearance and sound of the data points in order to focus on those elements of the data that are of particular interest.

When an analyst can focus on the data of particular interest, the length of time expended by the analyst to comprehend the data is decreased, such that a time savings of approximately an order of magnitude reduction can be realized. For example, analyses that currently take up to a week can be reduced to several hours. This is the case because currently the analyst has to stop to recheck his or her data, look at separate supporting data sets, or manually manipulate his or her visualization for a better perspective to correctly categorize the data. Such steps are no longer necessary with the currently disclosed embodiments.

An example of a data analysis scenario, referred to as situation awareness, involves the perception of objects of interest and their characteristics within a volume of time and space. White the x, y, and z axes can be used to plot the positions of objects, other dimensions such as time cannot be simultaneously displayed. Tracks can appear to cross when plotted in a flat 3D space, but the objects did not actually collide with each other because the objects crossed paths at different times. In many circumstances, the interest is in not only where (x, x, z position dimensions), but when (the time dimension). There are also many additional dimensions of interest such as detection quality, which individual sensors and which platforms detect the objects, velocity vectors, error ellipses, and system fault events. Some of the data is discrete, represented as yes/no or a finite set of enumerations. Some of the data is continuous, such as measurement data or quality calculations.

An embodiment of a situational awareness operational scenario involves the analysis of two weaving closely-spaced tracks. As noted in the previous paragraph, the analyst may be interested in which platforms and sensors detect the objects, identification (ID) determinations (i.e. hostile versus friend), and relationships between processing quality and system faults.

Another embodiment involves the analysis of sensor multi-path reflection effects. Specifically, sensor systems sometimes produce false duplicate aircraft tracks due to multi-path bouncing off of reflective objects, such as buildings or even a surface such as the ground. Such tracks may mirror the actual track. The phenomenon is difficult to detect when viewing 2D tracks or even flat-3D data plots unless the analyst takes the time to manipulate the view. When viewed in stereo 3D, however, the human analyst is able to quickly discern when the multi-path effect is occurring.

In a more general aspect however, an embodiment relates to a system for data display that includes a visual and/or aural analytics capability that augments a human analyst's ability to understand vast amounts of highly dimensional data. What is meant by ‘highly dimensional’ is data having many attributes of interest. For example, as noted above, for situational awareness data relating to the positions (x, y, z) of aircraft in an airspace, there could be additional data relating to time, velocity, and type of aircraft. While an example of aircraft position and aircraft related data are used in this disclosure, the system is applicable to any type of multi-dimension data analysis (e.g., cyber data, intelligence data, etc.).

There are at least three characteristics of such a system. First, a data analyst is provided with an avatar, and the analyst's avatar is immersed within data in the 3D environment. Specifically, the x, y, z axes are mapped to three dimensions of the data. The system allows the analyst to ‘fly’ through the data and zoom in and out, thereby enhancing the human analyst's ability to comprehend complex relationships within the three dimensions. In such a system, the analyst would be able to capture analysis output white “flying” through the data by snapping pictures, taking movies, or generating reports. It is noted that a display of less than three dimensions could also be used. Second, enhanced icon decorations are incorporated to map to additional data dimension subsets beyond 3D. Combinations of appearance features such as shape, color, size, hue or brightness represent the various data dimensions and provide meaning simultaneously to the analyst. Third, the data analyst can modulate both appearance and sound features that are mapped to additional dimension subsets of the data. Immersive 3D, enhanced icon decoration, and dimension modulation together allow the analyst to comprehend relationships within the many dimensions contained within the data set.

Both data and analyst ‘exist’ within the same environment. Display and aural features are mapped to additional dimensions beyond the plotted one, two, or three dimensions to allow the analyst to perceive additional relationships within the data.

In an embodiment, both discrete and continuous data can be visualized by mapping the display features of the icons to the dimensions within the data Those dimensions having discrete values can be visualized by decorating the icons with features such as color and shape to represent the discrete values within the data. Typically, different symbols are used such as triangles, squares, etc. However, in an embodiment, decorations of the icons are performed in ways that allow the analyst to immediately comprehend the meaning of the icon. That is, the appearance for a data point does not have to be limited to just a square or circle. It can take on the appearance of something instantly meaningful to the analyst, thereby enhancing perception of the data Those dimensions having continuous steady-state values can be rendered with features such color, brightness, blinking, bouncing, size, or transparency. Additionally, the symbol could be another plot of data., a velocity vector, an acceleration vector, or an error ellipse.

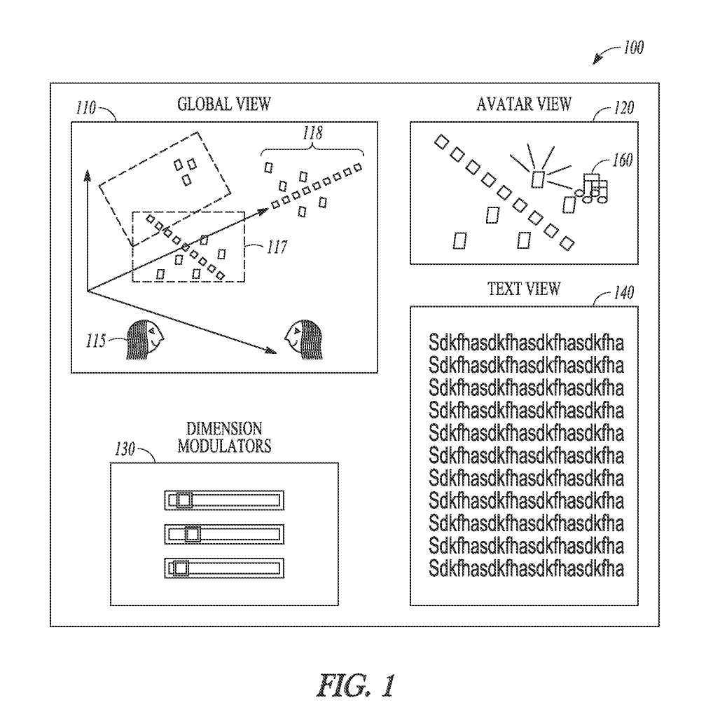

In an embodiment, a modulator, such as a slider mechanism 130 in FIG. 1, is used to control the appearance or sound of the data. For example, when brightness is used as a dynamic rendering, as the analyst moves a slider widget, those x, y, z points corresponding to the time as determined by the slider position turn bright. The effect is that the data is ‘replayed’ through time, changing brightness on the 3D display as the slider widget is moved, thereby providing a dynamic rendering of the dimension rather than the typical static rendering.

Given that a dynamic aspect is part of an embodiment, it is possible to introduce sound as an additional dimension feature. This allows for the aural perception of related data that is not rendered as an x, y, z point on the 3D display. In FIG. 1 for example, as the time slider 130 is moved, the data would be scrolling in the text display (140), but there is no way to highlight it on the x, y, z displays. A solution to this problem is to use sound as illustrated at 160. For example, when sound is used as a dynamic rendering, as the analyst moves the slider widget, those time points within the data set indicating the occurrence of fault events would emit a sound corresponding to that particular type of event. The effect is that the analyst would hear data's signature as a ‘song’ pattern that is played through time as the widget is moved.

FIG. 1 illustrates an example screen shot 100 that includes some of the characteristics of an embodiment as disclosed in the preceding and following paragraphs. In the embodiment of FIG. 1, there are two views of the data in the 3D environment. The first view 110 shows the global picture in 3D. All of the data could be potentially displayed in this view, subject to control by the analyst. The analyst would be able to control the orientation and zoom of the global picture and apply filters. Along with the data, the analyst is represented by an avatar 115 that is placed within the 3D environment. The analyst would be able to control its relative viewing position within the data, effectively ‘flying’ through the data to look for areas of interesting data. The second view 120 would be what the analyst selects or ‘sees’ in the avatar's field of view, or the avatar view. In FIG. 1, the view 120 is the selected avatar view 117, thereby filtering out the other data points at 118. The currently defined avatar field of view is also rendered in the global picture view 110 as the analyst flies through the data. This allows the analyst to orient himself/herself with respect to the global picture 110 as viewed in the avatar picture. Additionally, a detail screen can be used to display the details of the data in a textual format 140.

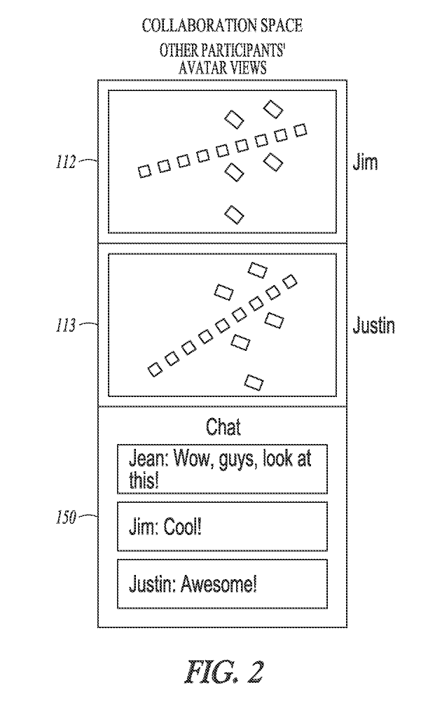

With networking, what an analyst sees could be replicated and shared with physically distributed colleagues for their comments in real-time. In an embodiment, more than one avatar could also be independently ‘flying around’ within the data. Therefore, the idea could be extended to support active collaboration among analysts over a network. Such an embodiment is illustrated in FIG. 2, wherein two colleagues can see the avatar view at 112 and 113. The various colleagues can correspond about the data in chat boxes 150.

In an embodiment, to address a potential problem that rendering all of the detail of all of the data icons may overwhelm the analyst's display, the level of detail could be based on the zoom factor. By analogy, just as a human cannot discern the facial features of individuals in a crowd from a distance, not all of the decorations on the data icons would be visible until the analyst zooms in closer in the avatar view 120.

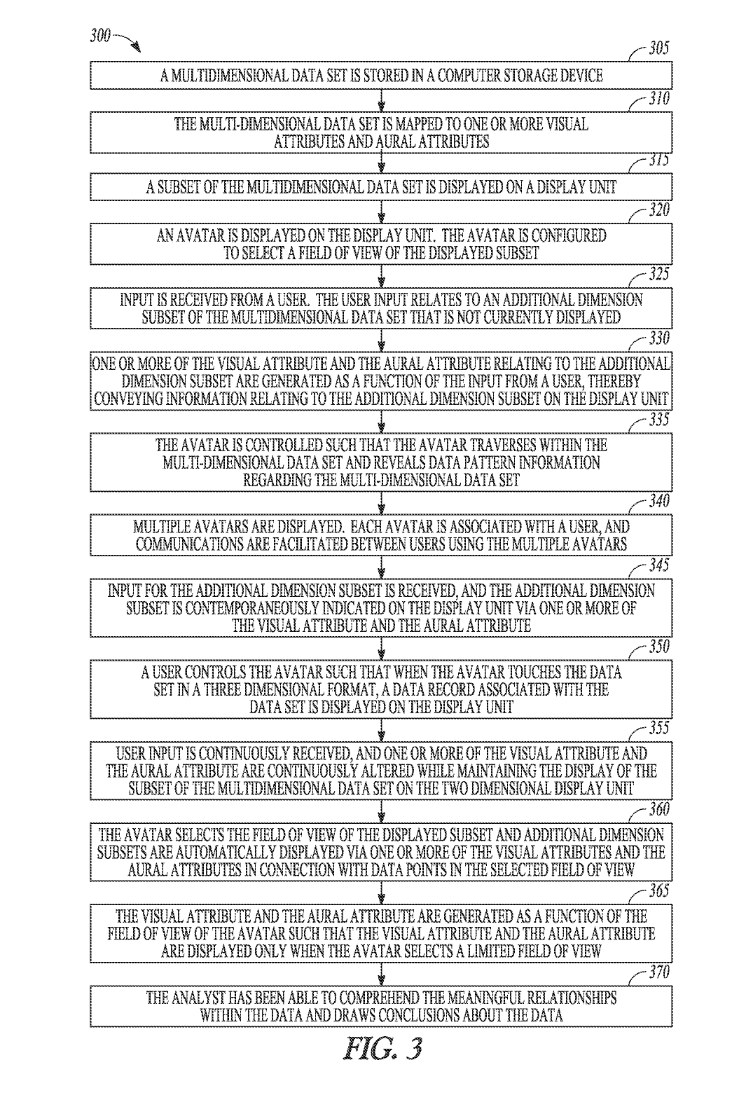

FIG. 3 is a flowchart of an example process 300 for analyzing multidimensional data. FIG. 3 includes a number of process blocks 305-370. Though arranged serially in the example of FIG. 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 3, at 305, a multidimensional data set is stored in a computer storage device. Al 310, the multi-dimensional data set is mapped to one or more visual attributes and aural attributes. At 315, a subset of the multidimensional data set is displayed on a display unit. At 320, an avatar is displayed on the display unit. The avatar is configured to select a field of view of the displayed subset. At 325, input is received from a user. The user input relates to an additional dimension of the multidimensional data set that is not displayed in the subset. At 330, one or more of the visual attribute and the aural attribute relating to the additional dimension are generated as a function of the input from a user, thereby conveying information relating to the additional dimension on the display unit.

At 335, the avatar is controlled such that the avatar traverses within the multi-dimensional data set and reveals data pattern information regarding the multi-dimensional data set. At 340, multiple avatars are displayed. Each avatar is associated with a user, and communications are facilitated between users using the multiple avatars. At 345, input for the additional dimension is received, and the additional dimension is contemporaneously indicated on the display unit via one or more of the visual attribute and the aural attribute. At 350, a user controls the avatar such that when the avatar touches the data set in a three dimensional format, a data record associated with the data set is displayed on the display unit. At 355, user input is continuously received, and one or more of the visual attribute and the aural attribute are continuously altered while maintaining the display of the subset of the multidimensional data set on the two dimensional display unit. This permits the user to view, compare, and analyze a plurality of additional dimensions on the display unit without generating an additional display on the two dimensional display unit. At 360, the avatar selects the field of view of the displayed subset and additional dimensions are automatically displayed via one or more of the visual attributes and the aural attributes in connection with data points in the selected field of view. At 365, the visual attribute and the aural attribute are generated as a function of the field of view of the avatar such that the visual attribute and the aural attribute are displayed only when the avatar selects a limited field of view. At 370, the analyst has been able to comprehend the meaningful relationships within the data and draws conclusions about the data.

### EXAMPLE EMBODIMENTS

Several embodiments and sub-embodiments have been disclosed above, and it is envisioned that any embodiment can be combined with any other embodiment or sub-embodiment. Specific examples of such combinations are illustrated in the examples below.

Example No. 1 is a system including one or more of a computer processor and a computer storage device configured to store a multidimensional data set, map the multi-dimensional data set to one or more visual attributes and aural attributes, display a subset of the multidimensional data set on a display unit, and display an avatar on the display unit. The avatar is configured to select a field of view of the displayed subset. The computer processor is also configured to receive input from a user. The user input relates to an additional dimension of the multidimensional data set that is not displayed in the subset. The computer processor is further configured to generate one or more of the visual attribute and the aural attribute relating to the additional dimension as a function of the input from a user, thereby conveying information relating to the additional dimension on the display unit.

Example No. 2 includes the features of Example No. 1, and optionally includes a system wherein the computer processor is configured to control the avatar such that the avatar traverses within the multi-dimensional data set and reveals data pattern information regarding the multi-dimensional data set.

Example No. 3 includes the features of Example Nos. 1-2, and optionally includes a system wherein the computer processor is configured to display multiple avatars, wherein each avatar is associated with a user, and wherein the computer processor is configured to facilitate communications between users using the multiple avatars.

Example No. 4 includes the features of Example Nos. 1-3, and optionally includes a system wherein the communication between the multiple avatars comprises one or more of a shared display and a chat box associated with the multiple avatars.

Example No. 5 includes the features of Example Nos. 1-4, and optionally includes a system wherein the user input for the additional dimension subset is received via a device.

Example No. 6 includes the features of Example Nos. 1-5, and optionally includes a system wherein the device includes a multi-dimensional control comprising one or more of a slide bar and a dial.

Example No. 7 includes the features of Example Nos. 1-6, and optionally includes a system comprising a device for additional dimension subsets of the multidimensional data set.

Example No. 8 includes the features of Example Nos. 1-7, and optionally includes a system wherein as the input for the additional dimension subset is received, the additional dimension subset is contemporaneously indicated on the display unit via one or more of the visual attribute and the aural attribute.

Example No. 9 includes the features of Example Nos. 1-8, and optionally includes a system wherein the multidimensional data set comprises multiple rows and multiple columns of tabular data.

Example No. 10 includes the features of Example Nos. 1-9, and optionally includes a system wherein the computer processor is configured to permit a user to control the display of the data in a text format corresponding to the data within an avatar's field of view.

Example No. 11 includes the features of Example Nos. 1-10, and optionally includes a system wherein the display of the subset of multidimensional data comprises a data icon.

Example No. 12 includes the features of Example Nos. 1-11, and optionally includes a system wherein one or more of the visual attribute and the aural attribute are associated with the data icon.

Example No. 13 includes the features of Example Nos. 1-12, and optionally includes a system wherein the subset comprises at least three dimensions of the multidimensional data set.

Example No. 14 includes the features of Example Nos. 1-13, and optionally includes a system wherein the computer processor is configured to continuously receive user input, and to continuously alter one or more of the visual attribute and the aural attribute, while maintaining the display of the subset of the multidimensional data set on the display unit, thereby permitting the user to view, compare, and analyze a plurality of additional dimensions on the display unit without generating an additional display on the display unit.

Example No. 15 includes the features of Example Nos. 1-14, and optionally includes a system wherein when the avatar selects the field of view of the displayed subset, and additional dimensions are automatically displayed via one or more of the visual attributes and the aural attributes in connection with data points in the selected field of view.

Example No. 16 includes the features of Example Nos. 1-15, and optionally includes a system wherein the field of view is displayed in a window on the display unit.

Example No. 17 includes the features of Example Nos. 1-16, and optionally includes a system wherein the generation of the visual attribute and the aural attribute are a function of the field of view of the avatar, such that the visual attribute and the aural attribute are displayed only when the avatar selects a limited field of view.

Example No. 18 is a computer readable storage device including instructions that when executed by a processor execute a process comprising storing a multidimensional data set, mapping the multi-dimensional data set to one or more visual attributes and aural attributes, displaying a subset of the multidimensional data set on a display unit, and displaying an avatar on the display unit. The avatar is configured to select a field of view of the displayed subset. The computer readable storage device also includes instructions for receiving input from a user. The user input relates to an additional dimension of the multidimensional data set that is not displayed in the subset. The computer readable storage device further includes instructions for generating one or more of the visual attribute and the aural attribute relating to the additional dimension as a function of the input from a user, thereby conveying information relating to the additional dimension on the display unit.

Example No. 19 is a process including storing a multidimensional data set in a computer storage device, using a computer processor to map the multi-dimensional data set to one or more visual attributes and aural attributes, displaying a subset of the multidimensional data set on a display unit, and displaying an avatar on the display unit. The avatar is configured to select a field of view of the displayed subset. The process also includes receiving into the computer processor input from a user. The user input relates to an additional dimension of the multidimensional data set that is not displayed in the subset. The process further includes generating with the computer processor one or more of the visual attribute and the aural attribute relating to the additional dimension as a function of the input from a user, thereby conveying information relating to the additional dimension on the display unit.

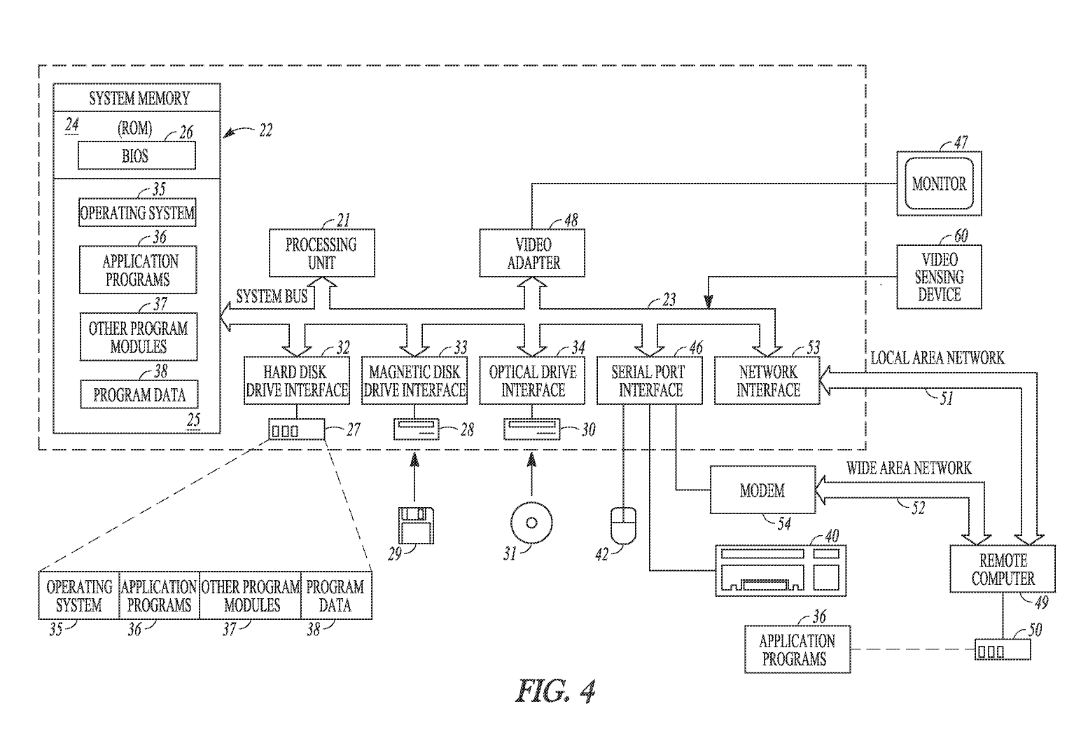

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or, memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R., §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies less than all features of a single disclosed embodiment. Thus the following claims are hereby incorporated into the Description of the Embodiments, with each claim standing on its own as a separate example embodiment.

1. A system comprising:
one or more of a computer processor and a computer storage device configured to:
store a multidimensional data set;
map the multi-dimensional data set to one or more visual attributes and aural attributes;
display a subset of the multidimensional data set on a display unit;
display an avatar on the display unit, wherein the avatar is configured to select a field of view of the displayed subset;
receive input from a user, the user input relating to an additional dimension of the multidimensional data set that is not displayed in the subset; and
generate one or more of the visual attribute and the aural attribute relating to the additional dimension as a function of the input from a user, thereby conveying information relating to the additional dimension on the display unit.

2. The system of claim 1, wherein the computer processor is configured to control the avatar such that the avatar traverses within the multi-dimensional data set and reveals data pattern information regarding the multi-dimensional data set.

3. The system of claim 2, wherein the computer processor is configured to display multiple avatars, wherein each avatar is associated with a user, and wherein the computer processor is configured to facilitate communications between users using the multiple avatars.

4. The system of claim 3, wherein the communication between the multiple avatars comprises one or more of a shared display and a chat box associated with the multiple avatars.

5. The system of claim 1, wherein the user for the additional dimension is received via a device.

6. The system of claim 5, wherein the device includes a multi-dimensional control comprising one or more of a slide bar and a dial.

7. The system of claim 5, comprising a device for each additional dimension subset of the multidimensional data set.

8. The system of claim 5, wherein as the input for the additional dimension subset is received, the additional dimension subset is contemporaneously indicated on the display unit via one or more of the visual attribute and the aural attribute.

9. The system of claim 1, wherein the multidimensional data set comprises multiple rows and multiple columns of tabular data.

10. The system of claim 1, wherein the computer processor is configured to permit a user to control the display of the data in a text format corresponding to the data within the avatar's field of view.

11. The system of claim 1, wherein the display of the subset of multidimensional data comprises a data icon.

12. The system of claim 11, wherein one or more of the visual attribute and the aural attribute are associated with the data icon.

13. The system of claim 1, wherein the subset comprises at least three dimensions of the multidimensional data set.

14. The system of claim 1, wherein the computer processor is configured to continuously receive user input, and to continuously alter one or more of the visual attribute and the aural attribute, while maintaining the display of the subset of the multidimensional data set on the display unit, thereby permitting the user to view, compare, and analyze a plurality of additional dimension subsets on the display unit without generating an additional display on the display unit.

15. The system of claim 1, wherein when the avatar selects the field of view of the displayed subset, additional dimension subsets are automatically displayed via one or more of the visual attributes and the aural attributes in connection with data points in the selected field of view.

16. The system of claim 1, wherein the field of view is displayed in a window on the display unit.

17. The system of claim 1, wherein the generation of the visual attribute and the aural attribute are a function of the field of view of the avatar, such that the visual attribute and the aural attribute are displayed only when the avatar selects a limited field of view.

18. A computer readable storage device comprising instructions that when executed by a processor execute a process comprising:
storing a multidimensional data set;
mapping the multi-dimensional data set to one or more visual attributes and aural attributes;
displaying a subset of the multidimensional data set on a display unit;
displaying an avatar on the display unit, wherein the avatar is configured to select a field of view of the displayed subset;
receiving input from a user, the user input relating to an additional dimension of the multidimensional data set that is not displayed in the subset; and
generating one or more of the visual attribute and the aural attribute relating to the additional dimension subset as a function of the input from a user, thereby conveying information relating to the additional dimension on the display unit.

19. The computer readable storage device of claim 18, comprising instructions for controlling the avatar such that the avatar traverses within the multi-dimensional data set and reveals data pattern information regarding the multi-dimensional data set.

20. A process comprising:
storing a multidimensional data set in a computer storage device;
using a computer processor to map the multidimensional data set to one or more visual attributes and aural attributes;
displaying a subset of the multidimensional data set on a display unit;
displaying an avatar on the display unit, wherein the avatar is configured to select a field of view of the displayed subset;
receiving into the computer processor input from a user, the user input relating to an additional dimension of the multidimensional data set that is not displayed in the subset; and
generating with the computer processor one or more of the visual attribute and the aural attribute relating to the additional dimension subset as a function of the input from a user, thereby conveying information relating to the additional dimension subset on the display unit.
